(19) United States
(12) Patent Application Publication
(10) Pub. No.: US 2005/0036906 A1
(43) Pub. Date: Feb. 17, 2005

(54) Biosensor

(75) Inventors: Katsuji Nakahara, Kouka-gun (JP); Kiyohiko Itoh, Suzuka-gun (JP); Shoji Miyazaki, Matsuyama-shi (JP); Hiroyuki Tokunaga, Onsen-gun (JP); Eriko Yamanishi, Onsen-gun (JP)

Correspondence Address: Barry E. Bretschneider;Morrison & Foerster LLP, Suite 300, 1650 Tysons Boulevard, McLean, VA, 22102, US

(73) Assignees: Toray Industries, Inc., Chuo-ku (JP); Matsushita Electric Industrial Co., Ltd., Kadoma-shi (JP)

(21) Appl. No.: 10/751,919

(22) Filed: Jan. 7, 2004

(30) Foreign Application Priority Data
Aug. 11, 2003 (JP) 2003-291150

(51) Int. Cl. G01N 21/00

(52) U.S. Cl. 422/58; 204/403.01

(57) ABSTRACT

A biosensor for analyzing specific components in an introduced liquid sample by reaction of the liquid sample with a reagent comprises a cavity into which the liquid sample is introduced, an air hole communicating from the cavity to outside, and a water repellent part having a water repellency at 43 mN/m or less in surface free energy and provided to at least a portion around the outlet of the air hole. By the water repellent part around the air hole, the liquid sample can be prevented from flowing out through the air hole, thereby achieving a high-accuracy measurement.

### BACKGROUND OF THE INVENTION

1. Field of the Invention

The present invention relates to a biosensor used for quantitating various specific components contained in a liquid sample, for example, specific components contained in a liquid of an organism such as a blood or an urine, and specifically to a biosensor having a cavity introduced with a sample liquid and an air hole communicating from the interior of the cavity to the outside for accelerating the introduction of the sample liquid, which can suppressing a sample liquid exhibiting a low surface tension to leak from the air hole.

2. Description of Prior Art

As a biosensor for quantitating specific components in a sample liquid, for example, known is a biosensor for determining a value of blood glucose by measuring a current generated by a reaction of glucose in blood with a reagent loaded in the sensor such as glucose oxidase or potassium ferricyanide. FIG. 1 is an exploded perspective view showing a conventional biosensor for determining a value of blood glucose (for example, JP-A-2002-214187). Where, the major structure of the biosensor shown in FIG. 1 is the same as that of a biosensor according to the present invention, and in the present invention, various improvements are added thereto as described later.

In FIG. 1, a working electrode 1 and a counter electrode 2 are formed on a substrate 5, made of an insulation material such as polyethylene terephthalate, by screen printing, etc. On these electrodes, a reagent layer 10 is formed, and the reagent contains, for example, glucose oxidase which is a ferment, potassium ferricyanide which is an electron transfer substance, and carboxymethyl cellulose which is a hydrophilic polymer. In order to form a cavity 11 for introducing a certain amount of blood and detecting a current generated by the reaction of the introduced blood with reagent layer 10, a spacer 7, cut away in a slot-like form at the portion above the electrodes and the reagent layer, and a cover 6, formed with an air hole 9, are laminated to each other on substrate 5.

In the biosensor having such a structure, blood is introduced into cavity 11 through suction inlet 8 by capillarity, and guided. up to a position where the electrodes and the reagent are present. The current generated by the reaction of the introduced blood and the reagent on the electrodes is detected by an external device (not shown) via leads 3 and 4.

However, in a case where the liquid sample sucked into the cavity is low in surface tension, for example, as in a blood extremely low in viscosity or a control liquid compounded with a water soluble polymer and the like (a standard liquid used generally for recognizing an abnormal operation of a measurement device and sold on the market), rarely observed is a phenomenon wherein the liquid sample leaks (flows out) from the interior of the cavity through air hole 9 communicating outside. When such a phenomenon occurs, the reagent fro reaction dissolved in the liquid sample may flow out to the outside of the cavity through the air hole 9, the concentration of the reagent in the cavity may be reduced, and reduction of the response value may be induced. Moreover, there is a problem that the liquid sample flown out may adhere to a hand when the sensor is removed from the measurement device. Such a phenomenon is liable to occur in a case where a surfactant and the like is applied onto the back surface of cover 6 (the surface brought into contact with the cavity) for the purpose of accelerating the introduction of the liquid sample into the cavity, and particularly in a condition of preservation under a high-temperature and high-humidity environment, because the surfactant is likely to be bled, the frequency of the phenomenon elevates.

### SUMMARY OF THE INVENTION

Accordingly, it is an object of the present invention to provide a biosensor which can suppress or prevent the leakage of a liquid sample through an air hole, thereby achieving a high measurement accuracy.

To achieve the foregoing and other objects, a biosensor according to the present invention is used for analyzing specific components in an introduced liquid sample by reaction of the liquid sample with a reagent, and the biosensor comprises a cavity into which said liquid sample is introduced; an air hole communicating from an interior of the cavity to an outside of the biosensor through an outlet of the air hole; and a water repellent part having a water repellency and provided to at least a portion around the outlet of the air hole. The water repellent part may be formed either at a portion around the outlet of the air hole only on an outer surface of an air hole-forming member, or at a portion including the outer surface and an inner circumferential surface of the air hole at at least the outlet portion of the air hole.

In an embodiment of the above-described biosensor, the cavity is formed using a substrate and a cover, the air hole is formed on the substrate or the cover, and the water repellent part is provided at least on an outer surface of the substrate or the cover.

In the biosensor, it is preferred that the water repellent part has a water repellency of 43 mN/m or less, more preferably, 30 mN/m or less, in surface free energy. Further, in order to give a water repellency to the water repellent part around the outlet of the air hole, it is necessary to perform a chemical treatment. As the chemical treatment, it is preferred to coat a substance with a high water repellency such as a silicone oil, or a silicone-based, hydrocarbon-based, fluorocarbon-based, wax-based, polyethyleneimine-octadecylisocyanate-based, poly(metha)acrylic ester-based, polystyrene-based, polyethylene-based or polypropylene-based resin.

In the biosensor according to the present invention, since the outer surface portion around the outlet of the air hole communicating the cavity has a water repellency, the liquid sample is prevented from flowing out from the air hole communicating outside by a suppressing force due to the water repellency, and an excellent biosensor exhibiting a high measurement accuracy can be provided.

Further objects, features, and advantages of the present invention will be understood from the following detailed description of preferred embodiments of the present invention.

### BRIEF DESCRIPTION OF THE DRAWINGS

Embodiments of the invention are now described with reference to the accompanying figure, which are given by way of example only, and are not intended to limit the present invention.

FIG. 1 is an exploded perspective view of a biosensor showing a main structure of both an embodiment of the present invention and a conventional biosensor.

### DETAILED DESCRIPTION OF PREFERRED EMBODIMENTS

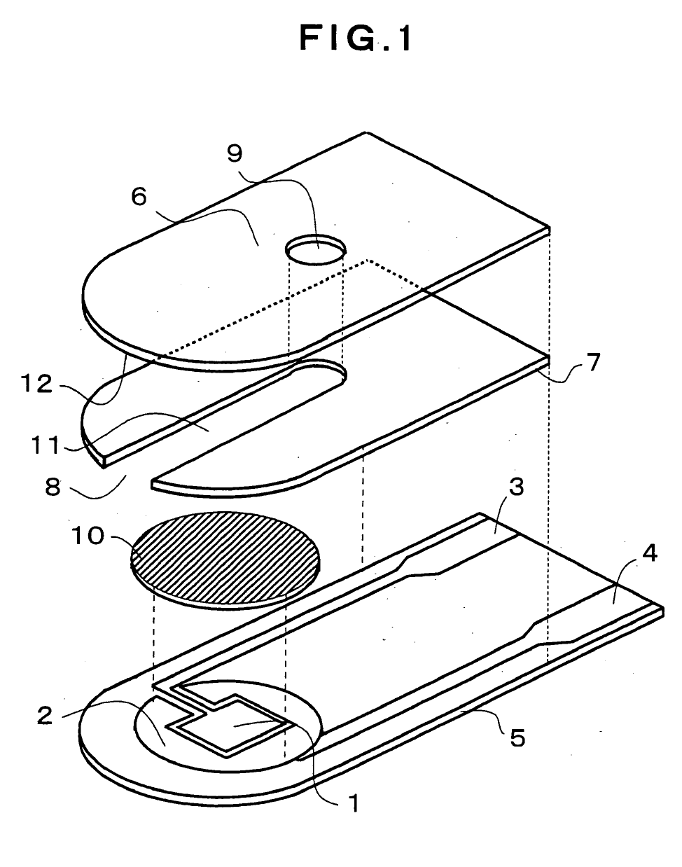

The present invention provides a biosensor for analyzing specific components in an introduced liquid sample by reaction of the liquid sample with a reagent, which has a cavity into which the liquid sample is introduced, and an air hole communicating from an interior of the cavity to an outside of the biosensor through an outlet of the air hole. Although the main structure is the same as that shown in FIG. 1 for a conventional biosensor, in the present invention, a water repellent part having a water repellency is provided to at least a portion (in particular, an outer surface portion) around the outlet of the air hole communicating outside. The water repellent part preferably has a water repellency of 43 mN/m or less in surface free energy, more preferably a water repellency of 30 mN/m or less in surface free energy.

In the biosensor according to the present invention, although the water repellency may be given to at least an outer surface portion around the outlet of the air hole 9 (see FIG. 1), a water repellency further may be given to the inner circumferential surface to obtain a better result. In the embodiment shown in FIG. 1, the water repellent part is provided on the outer surface of the cover 6 forming the outlet of the air hole 9. In a case where an air hole is formed on the side of substrate 5, the water repellent part may be provided on the outer surface of the substrate. The water repellent part may be provided either over the entire outer surface of the cover 6 or on only the surface portion around the outlet of the air hole 9.

The water repellency of the water repellent part is preferably 43 mN/m or less in surface free energy, more preferably 30 mN/m or less in surface free energy. In order to control the surface free energy at 43 mN/m or less, a method may be employed wherein a substance with a high water repellency such as a silicone oil, or a silicone-based, hydrocarbon-based, fluorocarbon-based, wax-based, polyethyleneimine-octadecylisocyanate-based, poly(metha)acrylic ester-based, polystyrene-based, polyethylene-based or polypropylene-based resin is dissolved or dispersed in an organic solvent or water, and it is coated onto the cover or mixed in a material forming the cover. Especially, it is possible to obtain a great effect by coating a silicone-based or fluorocarbon-based resin onto the surface of the cover. Where, as the silicone-based resin, a diorganopolysiloxane such as dimethylpolysiloxane, or diethylpolysiloxane, or phenylmethylpolysiloxane, or fluoro-group containing dialkylpolysiloxane, or vinyl-group containing dialkylpolysiloxane, or hydroxy-group containing dialkylpolysiloxane, or a mixtuture using a copolymer thereof as a main component, and/or a crosslinked substance such as methyl-hydrodiene polysiloxane, and/or an organic resin such as acrylic resin, epoxy resin or urethane resin having the above-described polyorganosiloxane as the side chain, or a silicone-system resin, can be raised. In particular, a substance prepared by crosslinking of polyorganosiloxane carried out by addition reaction or condensation reaction is preferable for achieving the purpose and effect of the present invention more clearly.

In this case, especially, addition reaction is more preferable. As such a preferable addition reaction, a method can be employed, wherein polyorganosiloxane and organohydrodiene polysiloxane represented by the following chemical formula are additionally reacted at a condition of existence of a platinum catalyst represented by chloroplatinic acid to form a crosslinkage structure of silicone. 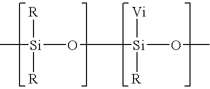
(In the chemical formula, R indicates an alkyl group and/or a phenyl group. and Vi indicates a double bond group such as a vinyl group and/or a hexenyl group.)

In this method, the curing reaction for obtaining the crosslinkage structure (curing by heating or curing by ultraviolet rays) can be carried out independently, respectively, or simultaneously. In a case of the simultaneous curing, it is preferred to heat the substance to be reacted together with a material (for example, a plastic film) forming an air hole at a temperature in a range of 70° C. to 200° C., preferably in a range of 120° C. to 160° C., for 15 seconds or more, although the preferred condition depends on the thermal resistance (thermally dimensional stability) of the plastic film.

A known additive such as a crosslinking agent, a coating property improving agent, an antistatic agent, an antioxidant or a dye may be added to the cover, or another resin component may be blended, unless the property aimed by the present invention is damaged.

The surface free energy of the portion around the air hole is preferably 43 mN/m or less, more preferably 30 mN/m or less. If the surface free energy is more than 43 mN/m, in a case where the liquid sample to be determined is a liquid sample with a low surface tension such as a water soluble polymer or a liquid containing a buffer component, the liquid sample sucked into the cavity flows out from the air hole, thereby reducing the measurement accuracy, and such a state is not preferred.

Although the adhesion amount of coating of the above-described substance having a high water repellency is not particularly limited, it is preferably in a range of 0.001 to 10 g/m², more preferably in a range of 0.01 to 5 g/m². If the adhesion amount of the coated substance is less than this range, there is a fear that the liquid sample sucked into the cavity flows out from the air hole, thereby reducing the measurement accuracy. On the contrary, if the adhesion amount of the coated substance is more than this range, there is a fear that the workability deteriorates. and a blocking is liable to occur. As aforementioned, although the substance may be coated over the entire outer surface of the cover 6, even if coated only onto the portion around the air hole, a desirable effect may be obtained.

Although the method for coating the substance having a high water repellency is not particularly limited, for example, a reverse coating method, a gravure coating method, a rod coating method, a comma coating method or a die coating method can be employed.

As the insulation substrate, spacer and cover, a plastic film, a synthetic parer, a paper or a composite sheet applied with a surface treatment can be used. In particular, a plastic film is preferred from the viewpoint of dimensional stability and durability.

As the material of the plastic film, polyester, polyolefin, polyamide, polyesteramide, polyether, polyimide, polyamideimide, polystyrene, polycarbonate, poly-p-phenylenesulfide, polyetherester, polyvinyl chloride and poly(metha)acrylic ester can be raised. Further, a copolymer or a blend thereof, and a material crosslinked therewith can also be used. Among the above-described plastic films, a polyester, for example, polyethylene terephthalate, polyethylene-2,6-naphthalate, polyethylene-α,β-bis(2-chlorophenoxy)ethane-4,4′-dicarboxylate, polybutylene terephthalate, etc. are preferred, and among these, in consideration of total properties in quality and economy such as mechanical properties and workability, polyethylene terephthalate is particularly preferable.

Although the thicknesses of the insulation substrate, spacer and cover are not particularly restricted, they are usually in a range of 10 μm to 500 μm, and preferably they are in a range of 20 μm to 400 μm, more preferably in a range of 301 μm to 300 μm.

### EXAMPLES

The determination and estimation methods in the present invention will be explained hereunder.

(1) Surface Free Energy:

Four kinds of liquids whose surface free energies and respective factors thereof (dispersion force, polar force and hydrogen bonding force) are already known are used (in the present invention, the values of water, ethylene glycol, formamide and methylene iodide described in Method IV by Panzer (Japan Adhesion Association journal, Vol. 15, No. 3, Page 96) are used), the contact angles with the respective liquids are determined using a contact angle meter CA-D type (produced by Kyowa Interface Science Corporation, a Japanese company) at a condition of a temperature of 20° C. and a humidity of 50% RH. The respective factors are calculated using the obtained values and the following equation derived from developed Fowkes' equation and Young's equation.
(γS^{d}·γL^{d})^{1/2}+(γS^{P}·γL^{P})^{1/2}+(γS^{h}γL^{h})^{1/2}=γL(1+cos θ)/2

Where, γL^{d}, γL^{P}, γL^{h} and γL indicate the respective factors of dispersion force, polar force and hydrogen bonding force of the measured liquid and the total surface free energy of the respective factors, and γS^{d}, γS^{P} and γS^{h} indicate the respective factors of dispersion force, polar force and hydrogen bonding force on the measurement surface. θ indicates a contact angle of the measured liquid at the measurement surface. The measurement is carried out for five points relatively to one measurement surface, and the mean value thereof is referred to as θ. The known values and θ are substituted for the above-described equation, and three factors of at the measurement surface are calculated by simultaneous equations. Where, for the calculation, “Find Minimum” of “Mathematica”, which is a mathematical software, is used.

(2) Adhesion Amount:

The weight of 100 cm² of a substrate coated with a coating solution is determined (A), the weight of 100 cm² of the substrate before coating is determined (B), and the adhesion amount (g/m²) is calculated by the equation: (A-B)×100.

[Methods for Preparing Respective Members]

Next, methods for preparing respective members will be explained.

(1 ) Spacer:

A spacer is prepared using a polyethylene terephthalate film “Lumirror” (Type 100E20) produced by Toray Industries, Inc. (a Japanese company) as its substrate.

(2) Cover A:

Cover A is prepared by using a substrate of a polyethylene terephthalate film “Lumirror” (Type 100T60) produced by Toray Industries, Inc. (a Japanese company) onto which an addition reaction type silicone (LTC350G, produced by Dow Corning Toray Silicone Co., Ltd. (a Japanese company)) is coated at an amount of 0.1 g/m , and providing an air hole having a diameter of 0.5 mm by punching press. The surface free energy of the portion around the air hole was 12.0 mN/m.

(3) Cover B:

Cover B is prepared by using a substrate of a polyethylene terephthalate film “Lumirror” (Type 100T60) produced by Toray Industries, Inc. (a Japanese company) onto which an acrylic resin is coated during the film formation process (in-line coating method) at an amount of 0.1 g/m², and providing an air hole having a diameter of 0.5 mm by punching press. The surface free energy of the portion around the air hole was 41.0 mN/m.

(4) Cover C:

Cover B is prepared by using a substrate of a polyethylene terephthalate film “Lumirror” (Type 100T60) produced by Toray Industries, Inc. (a Japanese company), and providing an air hole having a diameter of 0.5 mm by punching press. The surface free energy of the portion around the air hole was 46.9 mN/m.

[Method for Preparing Biosensors]

Electrodes comprising working electrode 1 and counter electrode 2 were provided by screen printing on substrate 5 of a polyethylene terephthalate film “Lumirror” (Type 250H10) produced by Toray Industries, Inc. (a Japanese company), thereon reagent layer 10 containing a ferment (glucose oxidase), an electron transfer substance (potassium ferricyanide), a hydrophilic polymer (carboxymethyl cellulose), etc. was formed, from the upper side thereof spacer 7 having a notched portion prepared by the above-described member preparing method (1) and cover A, B or C prepared by the above-described member preparing method (2), (3) or (4) were bonded to prepare a blood glucose sensor with a cavity into which blood was introduced. The diameter of air hole 9 was set at 0.5 mm, and a surfactant was coated on the back surfaces of the respective covers (surfaces in contact with the cavities).

Table 1 shows the comparison between the sensors of Examples and the conventional sensor with respect to the frequency of occurrence of flowing out of the liquid sample from the air hole and the sensor accuracy resulted by the presence of the flowing out. Because generally the flowing out of the liquid sample is remarkably observed in a preservation under a high-temperature and high-humidity environment, where, the estimation was carried out using a sensor preserved for one month in an environment at 40° C. and 80% RH. For this, a control liquid containing a water soluble polymer and having a small surface tension was used. In Table 1, the measurement of the flowing out of the liquid sample through the air hole was repeated 40 times (n=40) for respective Examples and Comparative Example, and the sensor accuracy was determined at a condition of n=20 by C.V. value.

As is evident from Table 1, the flowing out of the liquid sample observed in the sensor using cover C which is a conventional cover, is improved by using cover A or B. This improvement suggests that the surface free energy of the cover (of the portion around the air hole) greatly concerns the flowing out of the liquid sample.

Further, increase of the sensor accuracy was recognized by prevention of the flowing out. This suggests that it becomes possible to hold a constant amount of liquid sample in the cavity by preventing the flowing out of the liquid sample, and because the reagent for reaction dissolved in the liquid sample can be prevented from unnecessarily being flown out through the air hole, a uniform response value can be obtained.

TABLE 1

| | | Sensor of | | Conventional Sensor |
|---|---|---|---|---|
| Cover | | Example | | C |
| | Occurrence/ | A | B | (Comparative Example) |
| Flowing out | Parameter | 0/40 | 0/40 | 8/40 |
| Sensor | 40 mg/dl | 3.5% | 3.8% | 4.5% |
| Accuracy | 120 mg/dl | 1.9% | 1.4% | 3.1% |
| | 350 mg/dl | 1.2% | 1.5% | 2.6% |

Although the biosensors for determining the concentration of glucose in blood are exhibited in the above-described Examples, the liquid sample or substance to be determined and the type of the biosensor are not limited thereto. For example, as the liquid sample, saliva, intercellular liquid, urine or perspiration may be used as an organism sample liquid except blood, and the sensor may be applied to foods or drinking water. Further, as the target substance to be quantitated, except glucose, lactic acid, cholesterol, uric acid, ascorbic acid, bilirubin, etc. may be employed.

As the material used for electrodes of biosensors, there are carbon and noble metals such as gold, platinum or palladium, and as the method for forming the electrodes, a sputtering method, etc. can be employed except the aforementioned screen printing.

Further, as a ferment except glucose oxidase, lactate oxidase, cholesterol oxidase, cholesterol esterase, uricase, ascorbic acid oxidase, bilirubin oxidase, glucose dehydrogenase, lactate dehydrogenase, etc. can be employed. As an electron transfer substance except potassium ferricyanide, p-benzoquinone or a derivative thereof, phenazinemethosulfate, methylene blue, ferrocene or a derivative thereof, etc. can be employed. As a hydrophilic polymer except carboxymethyl cellulose, hydroxyethyl cellulose, hydroxypropyl cellulose, methyl cellulose, ethyl cellulose, ethylhydroxyethyl cellulose, carboxymethylethyl cellulose, polyvinyl alcohol, polyvinyl pyrolidone, polyamino acid such as polylysine, polystyrene sulfonic acid, gelatin or a derivative thereof, acrylic acid or a salt thereof, methacrylic acid or a salt thereof, starch or a derivative thereof, maleic anhydride or a salt thereof, agarose gel or a derivative thereof, etc. can be employed.

The reagent layer containing such reagents may be disposed at an arbitrary position in a cavity into which the liquid sample is introduced, other than a condition where the reagent layer is disposed on the entire area or a part of the portion on the electrodes, as long as the sensor performance is not damaged.

Further, in the measurement of current, there are a two-electrode system provided with a working electrode and a counter electrode, and a three-electrode system further added with a reference electrode or a detection electrode for detecting a lack of the liquid sample, and the three-electrode system can achieve a more accurate measurement.

Although embodiments of the present invention have been described in detail herein, the scope of the invention is not limited thereto. It will be appreciated by those skilled in the art that various modifications may be made without departing from the scope of the invention. Accordingly, the embodiments disclosed herein are only exemplary. It is to be understood that the scope of the invention is not to be limited thereby, but is to be determined by the claims which follow.

1. A biosensor for analyzing specific components in an introduced liquid sample by reaction of said liquid sample with a reagent comprising:
a cavity into which said liquid sample is introduced;
an air hole communicating from an interior of said cavity to an outside of said biosensor through an outlet of said air hole; and
a water repellent part having a water repellency and provided to at least a portion around said outlet of said air hole.

2. The biosensor according-to claim 1, wherein said cavity is formed using a substrate and a cover, said air hole is formed on said substrate or said cover, and said water repellent part is provided at least on an outer surface of said substrate or said cover.

3. The biosensor according to claim 1, wherein said water repellent part has a water repellency of 43 mN/m or less in surface free energy.

4. The biosensor according to claim 3, wherein said water repellent part has a water repellency of 30 mN/m or less in surface free energy.

5. The biosensor according to claim 2, wherein said water repellent part has a water repellency of 43 mN/m or less in surface free energy.

6. The biosensor according to claim 5, wherein said water repellent part has a water repellency of 30 mN/m or less in surface free energy.

7. The biosensor according to claim 1, wherein said water repellency is given to said water repellent part by a chemical treatment.

8. The biosensor according to claim 7, wherein said chemical treatment is a treatment for coating a substance with a water repellency.

9. The biosensor according to claim 8, wherein said substance with a water repellency is a substance selected from the group consisting of a silicone oil and silicone-based, hydrocarbon-based, fluorocarbon-based, wax-based, polyethyleneimine-octadecyliso cyanate-based, poly(metha)acrylic ester-based, polystyrene-based, polyethylene-based and polypropylene-based resins.
